(19) United States
(12) Patent Application Publication
(10) Pub. No.: US 2015/0312344 A1
(43) Pub. Date: Oct. 29, 2015

(54) Intelligent Media Production Systems and Services

(71) Applicant: Fueld Films, Inc., Austin, TX (US)

(72) Inventors: Brady J. Anderton, Parker, CO (US); Summer Lea Finley, Austin, TX (US); Jeffrey Jon Anderton, Parker, CO (US); David Patterson, Parker, CO (US)

(73) Assignee: Fueld Films, Inc., Austin, TX (US)

(21) Appl. No.: 14/630,486

(22) Filed: Feb. 24, 2015

Related U.S. Application Data
(60) Provisional application No. 61/944,020, filed on Feb. 24, 2014.

(51) Int. Cl. H04L 29/08; H04L 29/06

(52) U.S. Cl. CPC H04L 67/1097; H04L 67/1095; H04L 67/42

(57) ABSTRACT

Embodiments of intelligent media production system and services are presented. In one embodiment, a described method includes receiving an electronic request for a media production service from a media production client. The method may also include searching, using a data processor, a pre-compiled set of service providers a sub-set of media production service providers that are suitable for providing the media production service. Additionally, the method may include electronically presenting the sub-set of media production service providers to the media production client. The method may also include receiving a selection of a media production service provider from the media production client.

### CROSS-REFERENCE TO RELATED APPLICATIONS

This application claims priority to U.S. Provisional Patent Application No. 61/944,020 filed on Feb. 24, 2014, the entirety of which is incorporated herein by reference.

### FIELD

This disclosure relates generally to media production services, and more specifically, to intelligent media production systems and services.

### BACKGROUND

Media production can be a complex and costly undertaking, and the quality of the production is largely dependent on the quality of services providers involved in the production. Media productions include, for example, advertisements, television shows, movies or short films, music recordings, live stage shows, and the like. Media production often includes a variety of stages, such as content development; production planning, raw media production; post-production editing; formatting and packaging; and publication, sale or distribution.

For example, a company may contact an advertising agency for help preparing a marketing campaign. The advertising agency may develop various forms of advertisements, including radio advertisements, websites, web-based video advertisements, television advertisements, print advertisements, and the like. Upon approval of the advertising campaign, it is often up to the advertising agency to identify resources for production of the various types of media and to execute the advertising campaign. One challenge facing advertising agencies is that each advertising client may have different requirements. Examples of requirements that may differ from client to client include: budgets, schedules, content, available media outlets, creative direction or feel of the advertising campaign, etc. Therefore, it can be very challenging, costly, and time consuming for the advertising agency to identify service providers that are the right fit for the project.

As a result, advertising agencies may have a set of a few trusted production companies that they use on most projects. The production companies may face the same issues as described above when looking for service providers to meet a media production need. Indeed, these problems may extend all the way down the media production hierarchy. For example, a casting director may have a limited set of talent agencies or trusted actors that they use on every project, but it can be challenging to identify new talent. Music producers may have trouble identifying quality recording studios or talented musicians to use in the production of music. Film directors may similarly face challenges when looking for a film crew that is available and suitable for a given project. A challenge facing the media production industry is that it can be difficult to identify new talent, but new talent is often required to enhance creative aspects of a given project. Otherwise, the service provider's productions or services may become too stale or unoriginal to be commercially valuable. Additionally, as trends toward freelance service providers grows, it can be increasingly difficult to find the best service providers in the large production companies, and it can also be increasingly difficult to identify or keep track of quality talent.

Another challenging aspect of media production is cost containment, and one very costly aspect of the media production process is post-production editing. Often, post-production editing is done in-person between the client and an editor, and is often hosted by a post-production editing company. The equipment required for a post-production editing system can be very costly. Additionally, it may be necessary to pay extra for a good editor. Additional costs may including travel expenses such as transportation, hotel, per diem, and often a rate premium. Clients may want to visit the post-production house in person to ensure that the final product is acceptable, but may not wish to travel away from their home city for the post-production process.

These and other challenges are creating a need for a shift in the traditional media production paradigm. The following description presents methods and systems that provide benefits to the media production industry.

### SUMMARY

Embodiments of intelligent media production system and services are presented. In one embodiment, a described method includes receiving an electronic request for a media production service from a media production client. The method may also include searching, using a data processor, a pre-compiled set of service providers a sub-set of media production service providers that are suitable for providing the media production service. Additionally, the method may include electronically presenting the sub-set of media production service providers to the media production client. The method may also include receiving a selection of a media production service provider from the media production client.

An embodiment of a system comprises a processing device and a data storage device coupled to the processing device. the data storage device may include executable instructions configured to cause the processing device to receive an electronic request for a media production service from a media production client, search a pre-compiled set of service providers a sub-set of media production service providers that are suitable for providing the media production service, electronically present the sub-set of media production service providers to the media production client, and receive a selection of a media production service provider from the media production client.

An embodiment of a method for hosting a media production client for a post-production editing session with a remotely located media editor is also described. In an embodiment, the method includes receiving data associated with the post-production editing session from the remotely located media editor via a network interface. The method may also include presenting the data associated with the media editing session for review by the media production client using a media review device. Additionally, the method may include facilitating communication between the media production client and the remotely located media editor over the network.

Another embodiment of a system includes a data processing device and a data storage device coupled to the processing device. The data storage device may include executable instructions configured to cause the processing device to receive data associated with the post-production editing session from the remotely located media editor via a network interface, present the data associated with the media editing session for review by the media production client using a media review device, and facilitate communication between the media production client and the remotely located media editor over the network.

Still another embodiment of a system is presented. In this embodiment, the system includes a post-production network. The system may also include an application server coupled to the post-production network and configured to host and provide remote access to a post-production software application. Additionally, the system may include an editor interface system coupled to the post-production network and configured to access the post-production software application. The system may further include a data storage device configured to centrally store media files and post-production data for remote access by the editor interface system. Additionally, the system may include a host interface system configured to provide interactive interface between a media production client hosted at a host facility and a remotely located editor via a connection between the host interface system and the editor interface system.

### BRIEF DESCRIPTION OF THE DRAWINGS

The present disclosure is illustrated by way of example and is/are not limited by the accompanying figures, in which like references indicate similar elements. Elements in the figures are illustrated for simplicity and clarity and have not necessarily been drawn to scale.

FIG. 1 is a schematic block diagram illustrating one embodiment of a system for intelligent media production.

FIG. 2 is a schematic block diagram illustrating one embodiment of a data processing system which may be specially configured to perform operations for intelligent media production.

FIG. 3 is a schematic block diagram illustrating one embodiment of a server configured for intelligent media production services.

FIG. 4 is a schematic block diagram illustrating a further embodiment of a server configured for intelligent media production services.

FIG. 5 is a schematic block diagram illustrating one embodiment of a client interface device.

FIG. 6 is a schematic block diagram illustrating one embodiment of a service provider interface device.

FIG. 7 is a schematic block diagram illustrating one embodiment of a collective broker interface device.

FIG. 8 is a schematic flowchart diagram illustrating one embodiment of a method for intelligent media production.

FIG. 9 is a schematic flowchart diagram illustrating another embodiment of a method for intelligent media production.

FIG. 10 is a schematic flowchart diagram illustrating one embodiment of a method for adding a service provider to a collective database of media production service providers.

FIG. 11 is a schematic block diagram illustrating one embodiment of a system for remote post-production editing.

FIG. 12 is a schematic block diagram illustrating one embodiment of an application server for remote post-production editing.

FIG. 13 is a schematic block diagram illustrating one embodiment of an editor interface system for remote post-production editing.

FIG. 14 is a schematic block diagram illustrating one embodiment of a host interface system for remote post-production editing.

FIG. 15 is a schematic flowchart diagram illustrating one embodiment of a method for remote post-production editing.

FIG. 16 is a schematic flowchart diagram illustrating another embodiment of a method for remote post-production editing.

### DETAILED DESCRIPTION

The present embodiments provide a framework for intelligent media production services. For example, embodiments of systems described herein facilitate collection of service provider information and consolidation of the service provider information into a searchable database, which is usable for matching service providers to media production requests. The framework provides a vehicle for a global talent collective or co-operative. This pool of service providers may provide information which may be stored in the database. The information may pertain to the services providers capabilities, credentials, work history, etc.

A collective broker may vet the service provider to ensure that the service provider actually has the qualifications and capabilities described. The collective broker may additionally, facilitate matching of the service provider to potential clients or customers. As used herein, the term “collective broker” means an individual or organization that provides brokerage services to media production service providers and media production clients or customers. The brokerage services may include matching the services providers to specific client projects.

Additionally, embodiments described herein provide a cost-effective post-production editing system and method. The post-production editing session may be hosted by a host company, such as a media production company or a post-production house. The editor may be located remotely from the host environment, but may interact with the client in the host environment by means of a virtual presence system. The virtual presence system may enhance the customer's experience by allowing interactive and direct communication between the customer and the editor. Beneficially, such methods and systems may substantially reduce post-production costs, while providing remote access to editors with top qualifications.

Additional embodiments facilitate central hosting and storage of media files, media editing software, and editing data. Such embodiments reduce overhead costs by minimizing the equipment and software required to implement a hosted editing environment in smaller satellite offices of a production company or a post-production company.

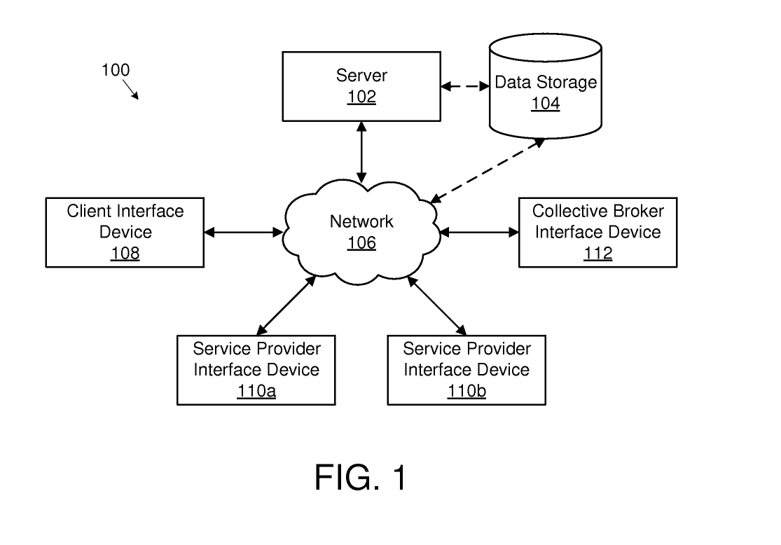

FIG. 1 is a schematic block diagram illustrating one embodiment of a system 100 for intelligent media production. In an embodiment, the system includes a server 102. The system may also include a data storage device 104. The server 102 may be coupled to the data storage device 104 through a direct data connection, or through the network 106. The system 100 may also include a client interface device 108 for communicating information with a client. Additionally, the system 100 may include one or more service provider interfaces 110a-b for communicating information with a service provider. In a further embodiment, the system may include a collective broker interface device 112 for communicating information with a collective broker. One of ordinary skill in the art will recognize that either the server 102 or the collective broker interface device 112 may be omitted from the system. For example, in some embodiments, the collective broker interface device 112 may replace the server 102 from a functionality viewpoint. Alternatively, the functionality of both the server 102 and the collective broker interface device 112 may be integrated into a single collective brokerage management device (not shown).

Embodiments of the process flows described herein can be better understood in view of the embodiment of FIG. 1. For example, a media production client may enter information comprising an electronic request for a media production service via client interface device 108. The server 102 may search a database of media production service providers stored on data storage device 104. The database may be compiled of information received from service providers via service provider interface devices 110a, b. In an embodiment, a request for additional information may be generated and set to a sub-set of the service providers. The specified service providers may provide additional information, such as project quotes, schedule information, service agreements, etc. via service provider interface devices 110a, b. For example, a first identified film director may enter requested information via a first service provider interface 110a and a second film director may enter requested information via a second service provider interface 110b.

In an embodiment, the collective broker may review the search results and the additional information provided by the service providers. In a further embodiment the collective broker may generate, or approve an automatically generated presentation the sub-set of service providers for the media production client. The server 102 may then communicate the electronic presentation of the sub-set of service providers to the client interface 108. The media production client may enter a selection and the selection may be communicated from the client interface 108 back to the server 102 or to the collective broker interface device 112.

In an embodiment, the service provider interface device 110a, b may be computer systems comprising a specially configured software application or web interface for accessing a web application configured for interaction with server 102. In some embodiments, client interface device 108 and collective broker interface device 112 may be similarly programmed computer devices.

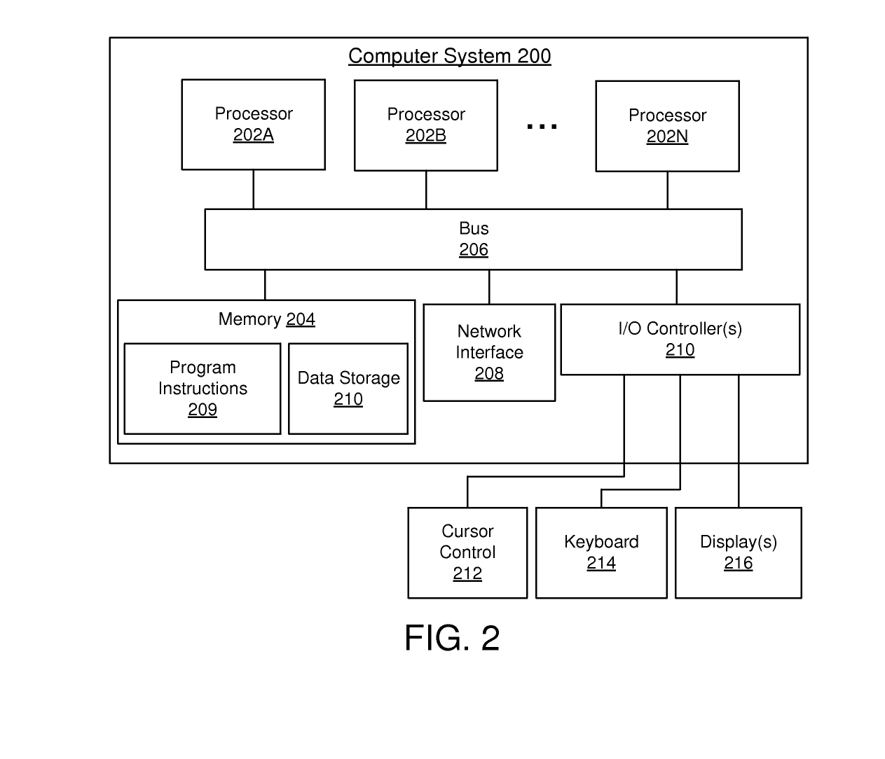

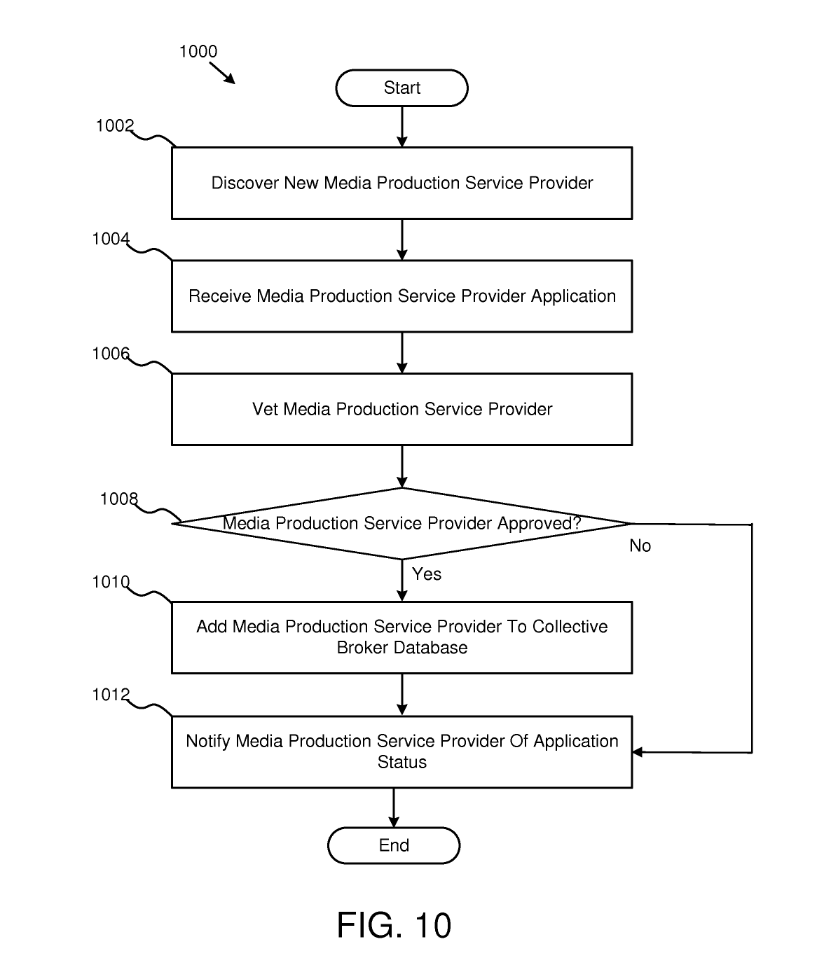

FIG. 2 is a schematic block diagram illustrating one embodiment of a computer system 200 configurable for intelligent media production. In one embodiment, server 102 may be implemented on a computer system similar to the computer system 200 described in FIG. 2. Similarly, client interface device 108 may be implemented on a computer system similar to the computer system 200 described in FIG. 2. Service provider interface device 110a-b may also be implemented on a computer system similar to the computer system 200. Additionally, collective broker interface device 112 may be implemented on a computer system similar to the computer system 200. Additionally, some similar components of system 1000 described in FIG. 10 may also be implemented on a computer system similar to the computer system 200 described in FIG. 2. In various embodiments, computer system 200 may be a server, a mainframe computer system, a workstation, a network computer, a desktop computer, a laptop, or the like.

As illustrated, computer system 200 includes one or more processors 202A-N coupled to a system memory 204 via bus 206. Computer system 200 further includes network interface 208 coupled to bus 206, and input/output (I/O) controller(s) 210, coupled to devices such as cursor control device 212, keyboard 214, and display(s) 216. In some embodiments, a given entity (e.g., server 102, client interface device 108, service provider interface device 110a-b, or collective broker interface device 112) may be implemented using a single instance of computer system 200, while in other embodiments multiple such systems, or multiple nodes making up computer system 200, may be configured to host different portions or instances of embodiments (e.g., client interface device 108 and service provider interface devices 110a-b).

In various embodiments, computer system 200 may be a single-processor system including one processor 202A, or a multi-processor system including two or more processors 202A-N (e.g., two, four, eight, or another suitable number). Processor(s) 202A-N may be any processor capable of executing program instructions. For example, in various embodiments, processor(s) 202A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 202A-N may commonly, but not necessarily, implement the same ISA. Also, in some embodiments, at least one processor(s) 202A-N may be a graphics processing unit (GPU) or other dedicated graphics-rendering device.

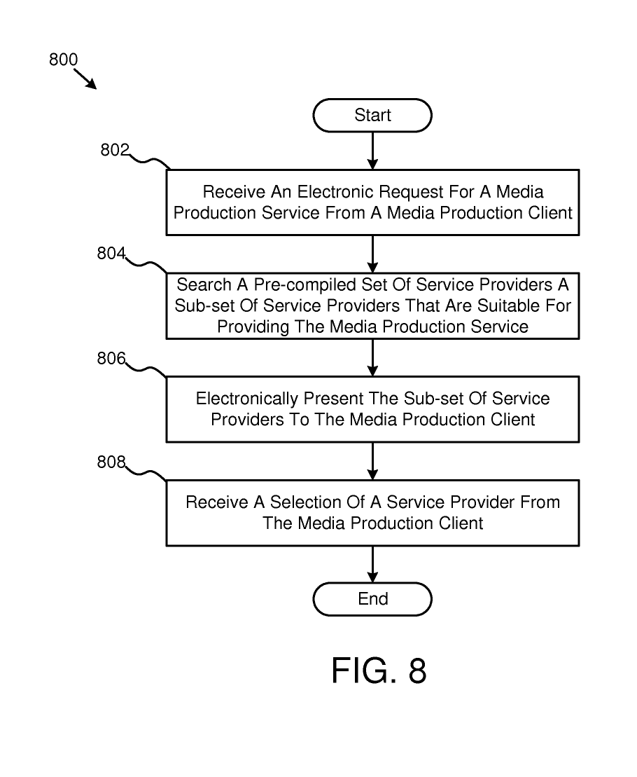

System memory 204 may be configured to store program instructions and/or data accessible by processor(s) 202A-N. For example, memory 204 may be used to store software program and/or database shown in FIGS. 8-10 and 15-16. In various embodiments, system memory 204 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 204 as program instructions 209 and data storage 210, respectively. In other embodiments, program instructions and/or data may be received, sent or stored upon different types of computer-accessible media or on similar media separate from system memory 204 or computer system 200. Generally speaking, a computer-accessible medium may include any tangible, non-transitory storage media or memory media such as electronic, magnetic, or optical media—e.g., disk or CD/DVD-ROM coupled to computer system 200 via bus 206, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 206 may be configured to coordinate I/O traffic between processor 202, system memory 204, and any peripheral devices including network interface 208 or other peripheral interfaces, connected via I/O controller(s) 210. In some embodiments, bus 206 may perform any necessary protocol, timing or other data transformations to convert data signals from one component (e.g., system memory 204) into a format suitable for use by another component (e.g., processor(s) 202A-N). In some embodiments, bus 206 may include support for devices attached through various types of peripheral buses, such as a variant of the Peripheral Component Interconnect (PCI) bus standard or the Universal Serial Bus (USB) standard, for example. In some embodiments, the operations of bus 206 may be split into two or more separate components, such as a north bridge and a south bridge, for example. In addition, in some embodiments some or all of the operations of bus 206, such as an interface to system memory 204, may be incorporated directly into processor(s) 202A-N.

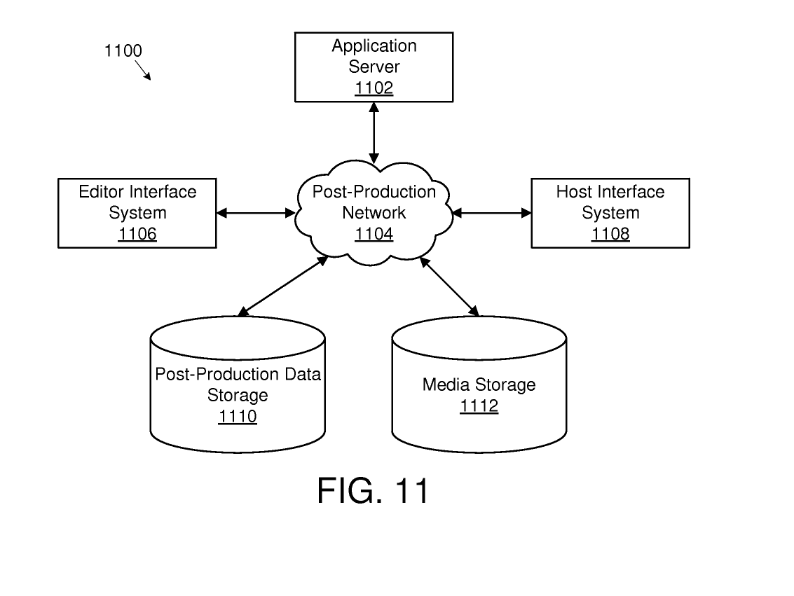

Network interface 208 may be configured to allow data to be exchanged between computer system 200 and other devices, such as other computer systems attached to server 102, client interface device 108, service provider interface devices 110a-b, collective broker interface device 112, or similar components of FIG. 11, for example. In various embodiments, network interface 208 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 210 may, in some embodiments, enable connection to one or more display terminals, keyboards, keypads, touch screens, scanning devices, voice or optical recognition devices, or any other devices suitable for entering or retrieving data by one or more computer system 200. Multiple input/output devices may be present in computer system 200 or may be distributed on various nodes of computer system 200. In some embodiments, similar I/O devices may be separate from computer system 200 and may interact with computer system 200 through a wired or wireless connection, such as over network interface 208.

As shown in FIG. 2, memory 204 may include program instructions 209, configured to implement certain embodiments described herein, and data storage 210, comprising various data accessible by program instructions 209. In an embodiment, program instructions 209 may include software elements of embodiments illustrated in FIGS. 8-10 and 15-16. For example, program instructions 209 may be implemented in various embodiments using any desired programming language, scripting language, or combination of programming languages and/or scripting languages. Data storage 210 may include data that may be used in these embodiments such as, for example, data storage 104. In other embodiments, other or different software elements and data may be included.

A person of ordinary skill in the art will appreciate that computer system 200 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

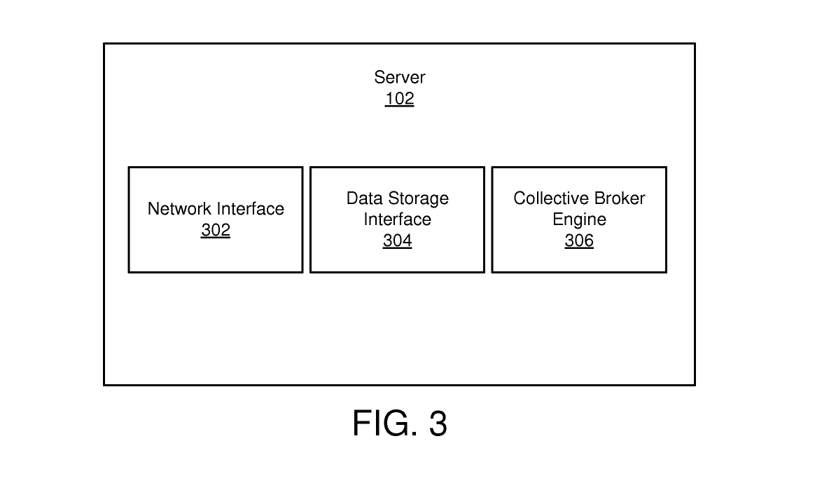

Embodiments of server 102, client interface device 108, service provider interface devices 110a-b, collective broker interface device 112, application server 1002, editor interface system 1006, and host interface system 1008 described in FIGS. 3-7 and 11-13 may be implemented in a computer system that is similar to computer system 200. In one embodiment, the elements described in FIGS. 2-7 and 11-13 may be implemented in discrete hardware modules. Alternatively, the elements may be implemented in software-defined modules which are executable by one or more of processors 202A-N, for example.

FIG. 3 is a schematic block diagram illustrating one embodiment of a server 102 configured for intelligent media production services. The server 102 may include a network interface 302 for communicating with network 106. The server 102 may also include a data storage interface 304 for communicating data with data storage 104. Additionally, the server 102 may include a collective broker engine 306 configured to perform operations for matching a media service provider that is a member of a collective of media service providers with a media production client for provision of media production services.

Network interface 302 may include, for example network interface 208 hardware. Additionally, network interface 302 may include drivers, network address data, and other configuration information that may be required to allow the server 102 to interact with the client interface device 108, the service provider interfaces 110a, 110b, and the collective broker interface device 112 over network 106. In a further embodiment, the network interface 302 may include information, such as security keys, which enable the server 102 to communicate securely over network 106. Additionally, network interface may be configured to receive a request for media production services from a media production client—e.g., via client interface device 106. Network interface 302 may be further configured to communicate information requests to service provider interface devices 110a, b. Additionally network interface 302 may be configured to communicate service provider search results and additional information to collective broker interface device 112. Network interface device may additionally communicate a proposal of service providers to media production client via client interface device 108. Network interface 302 may additionally receive a selection of media service providers from client interface device 108. One of ordinary skill will recognize additional information which may be communicated to and from the server 102 via network interface 304.

Data storage interface 304 may include bus 206. In another embodiment, data storage interface 304 may include a Small Computer System Interface (SCSI), Serial Advanced Technology Attachment (SATA), Fibre-Channel Arbitrated Loop (FC-AL), gigabit Ethernet, or other Storage Area Network (SAN) interface. Data storage interface 304 may further include database interface or management functionality. For example, database interface may include SQL code, or other database interface code, configured to query a database of service providers in the collective, which may be stored on data storage 104.

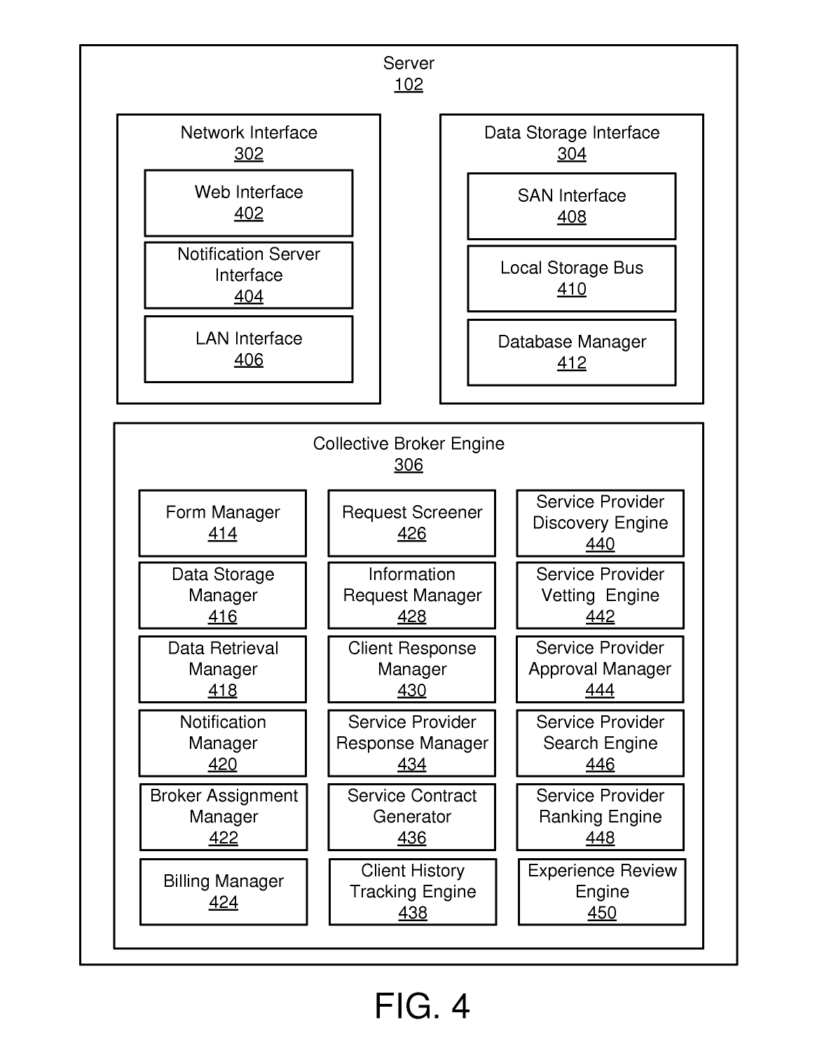

Collective broker engine 306 may use information about the media service request received from the client interface device 108 to generate a query of the service provider database on data storage 104. The collective broker engine 306 may additionally present search results, either to the collective broker interface 112 or to the client interface 108, depending on the search configuration. In a further embodiment, the collective broker engine 306 may request additional information from media production service providers and display information associated with the media production request to a collective broker via collective broker interface device 112. Additional embodiments of collective broker engine 306 are described below with reference to FIG. 4.

FIG. 4 is a schematic block diagram illustrating a further embodiment of a server 102 configured for intelligent media production services. In an embodiment, network interface 302 may include a web interface 402, such as an Ethernet interface, Wi-Fi interface, or mobile data interface for communication of data to and from a Wide Area Network (WAN) or the Internet. Network interface 302 may additionally include a notification server interface 404. The notification server interface 404 may include an interface to an email server, such as a Simple Mail Transfer Protocol (SMTP) server, or the like. Notification server interface 404 may also include a telephone system interface for communicating automated voice message or automatically connecting a collective broker to the service provider via a telephone system. For example, collective broker interface device 112 may include a soft phone application for communicating via a Voice over Internet Protocol (VoIP) telephone system. Notification server 404 may include an autodialer for connecting the soft phone with a telephone number associated with the media production service provider listed in his or her record in the database. Notification interface 404 may further include a text messaging server, or the like.

LAN interface 406 may include a communication interface for securely connecting server 102 to data storage 104 and/or collective broker interface device 112 if they are co-located on the same Local Area Network (LAN).

Data storage interface 304 may include a SAN interface 408, a local storage bus 410, and/or a database manager 412 in various embodiments. SAN interface 408 may handle communications with data storage 104 in configurations where data storage 104 is connected to server 102 via a SAN. SAN protocols may include Small Computer System Interface (SCSI), Serial Advanced Technology Attachment (SATA), Fibre-Channel Arbitrated Loop (FC-AL), gigabit Ethernet, or other Storage Area Network (SAN) interfaces. In various further embodiments, the SAN may be expanded to include cloud storage interfaces. For example, data storage 104 may be a cloud storage service. Local storage bus may include bus 206, or other local data storage bus. Local data storage 104 may be configured to communicate with data storage 104 in configuration where data storage device 104 is an attached local data storage device. Local data storage bus 410 may include a parallel data connection, a Universal Serial Bus (USB) data connection, or a wireless data bus connection.

Database manager 412 may be configured to facilitate communication of data between a database of collective service providers stored on data storage device 104 and the collective broker engine. For example, database manager 412 may include underlying SQL or other database interface code configured to query the database and return search results to the collective broker engine 306. One of ordinary skill will recognize additional database management functions that may be handled by database manager 412, such as storage of new service provider profiles, storage of media production service request information, etc.

In various embodiments, collective broker engine 306 may include one or more of the additional modules depicted in FIG. 4. The additional modules may include a form manager 414, a data storage manager 416, a data retrieval manager 418, a notification manager 420, a broker assignment manager 422, a billing manager 424, a request screener 426, an information request manager 428, a client response manager 430, a service provider response manager 434, a service contract generator 436, a client history tracking engine 438, a service provider discovery engine 440, a service provider vetting engine 442, a service provider approval manager 444, a service provider search engine 446, a service provider ranking engine 448, and an experience review engine 450. One of ordinary skill will recognize that some of these modules may be omitted, or that additional modules may be included which are not discussed herein, but which may achieve similar technical or functional results. For example, functionality of one or more of the modules described in FIG. 4 may be combined, etc.

In an embodiment, the form manager 414 may be configured to handle generation, modification, display, and information retrieval associated with one or more forms configured for use with collective broker engine 306. Forms may include media production service request forms, media production service provider application forms, additional information response forms, etc. In one embodiment, form manager 414 may provide an interface for creating or modifying forms. In an embodiment, new forms may be created from scratch, or based upon templates stored by form manager 414. In other embodiments, existing forms may be modified. The forms may be used to obtain information needed by collective broker engine 306 to receive and respond to media production service requests. Additionally, form manager 414 may be configured to present forms to the client interface device 108, the service provider interface device 110a, b, and/or to the collective broker interface device 112. In such an embodiment, the forms may be communicated via HTML, Extensive Markup Language (XML), PHP, or the like.

Data storage manager 416 may be configured to interface with data storage interface 304 to store data received by the server from, e.g., client interface device 108, service provider interface devices 110a, b, or collective broker interface device 112, on the data storage device 104. Data storage manager 416 may further aggregate and/or format received data for storage in database records on the data storage device 104.

Data retrieval manager 418 may similarly be configured to interface with data storage interface 304. The data retrieval manager may handle queries of the service provider collective database stored on data storage device 104 in response to one or more media production service requests. For example, data retrieval manager 418 may use information obtained from a media production client via one or more media production request forms to structure an SQL query of the media production service provider database. The returned results may be formatted or organized in a report or query response form. In an embodiment, the results may be displayed to the collective broker interface device 112. In another embodiment, the results may be displayed to client interface device 108. In still another embodiment, the results may be used to structure an information request to service provider interface device 110a as described further with reference to block 428.

In an embodiment, the notification manager 420 may be configured to generate an automated notification in response to a media production service request. For example, the notification manager 420 may generate an automated request acknowledgement to the media production client. The acknowledgement may be communicated via email, text message, telephone call, or to a client interface portal. In a further embodiment, the notification manager 420 may notify a media production service provider that he/she has been identified in a search. The notification manager 420 may also notify a collective broker that he/she has been assigned to fulfil a new media production service request. One of ordinary skill will recognize additional notifications that may be generated or communicated by notification manager 420. The notification manager may automatically generate the notifications, may generate a template notification for approval by a collective broker, may handle communication of original notifications generated by the collective broker, or the like.

In embodiments requiring interaction with a collective broker, the broker assignment manager 422 may handle assignments of media production service requests to a collective broker. In an embodiment, the assignment manager 422 may track the collective broker's work load as compared with other collective brokers and make assignments based on a balance of work load. Alternatively, the assignment manager 422 may make broker assignments in response to information provided in the media production service request, such as the geographic location of the media production client, the type of requested service, or the like. In an embodiment, the broker assignment manager 422 may communicate request assignments to the collective brokers via the notification manger 420. In still further embodiments, the broker assignment manager 422 may automatically notify the media production client of the broker assignment, and provide contact information for reaching the collective broker.

The billing manager 424 may automatically handle billing for collective search and matching services. For example, billing manager 424 may automatically track costs associated with a received request. Billing manager 424 may further handle billing for services on behalf of the media production service provider. Billing manager 424 may automatically generate invoices for service provided by the collective broker engine 306. In a further embodiment, the billing manager 424 may automatically generate invoices for services provided by the collective broker. In still a further embodiment, the billing manager 424 may automatically generate invoices associated with the services provided by the media production service provider. In a further embodiment, billing manager 424 may generate an aggregated invoice for service provided by multiple media production service providers. Billing manager 424 may automatically charge an account provide by the media production client for services rendered. For example, billing manager 424 may automatically charge a credit card account or checking account. In another embodiment, the billing manager may charge an internal account and provide a periodic invoice for services rendered within a predetermined time period. In still a further embodiment, the billing manager 424 may automatically credit a media production service provider's account for funds received from the media production client. One of ordinary skill may recognize additional billing services that may be performed by billing manager 424 according to the present embodiments.

Request screener 426 may automatically screen media production service requests to verify that the requests are complete and valid. For example, the request screener may include functions for verifying that the request originates from a genuine or registered client, rather than an automated web bot attempting to crawl data stored in the collective database. Such screening functions may include account registration and/or authentication, provision of authentication information such as a CAPTCHA, or the like. In a further embodiment, the request screener 426 may verify that the request is complete and that all required information has been provided by the client. If the request screener 426 determines that the request is incomplete, the request screener 426 may cause the notification manager 420 to notify the client and request additional information for completing the request.

In an embodiment, information request manager 428 may receive media production search request and generate one or more information requests for service providers identified by the service provider search engine 446 in response to the request. The information requests may include, for example, whether the service provider has availability to perform the service according to a specified schedule. The information request may also include a request for a quotation or estimation of costs. In another embodiment, the information request may include an indication of whether the service provider is capable of providing the service within a specified budget. The information request may additionally include an indication of whether the service provider has one or more special capabilities, such as shoot-specific skills, equipment, or experience. In still other embodiments, the information request may include an indication of whether the service provider is a member of a service union, etc. The information request manager 430 may interact with notification manager to provide the information request via email, text message, telephone, and/or via a web application or portal. For example, the information request manager may issue a fillable form to the service provider eliciting specific responses.

The client response manager 430 may handle responses to requests for additional information from clients. For example, the client response manager 430 may update a record stored in a database of client requests with the additional information received from the client in response to an information request. Similarly, the service provider response manager 434 may handle responses to requests for additional information from service providers. The additional information provided by service providers may be added to a service provider's profile, history, or the other records associated with the service provider. Additionally, the information provided by the service provider may be used by a collective broker to generate a presentation of service providers for selection by the client.

Upon selection of service providers by a client, the service contract generator 436 may automatically generate one or more service contracts. In one embodiment, the service contracts may be automatically generated using information obtained from the client by the media production request and from the media production service provider in the service provider application and additional information request. The contract may include, for example, an identification of the parties, a description of the project or services to be provided, a designation of schedule and/or budget, etc. The service contract generator 436 may provide a draft of the service contracts to the collective broker for revision and/or approval. In another embodiment, the service contract generator 436 may generate a service contract between the client and the collective broker or collective brokerage search service. The service contract generator 436 may then handle distribution of the contract. In a further embodiment, the service contract generator may facilitate electronic execution of the service contracts.

The client history tracking engine 438 may track and record information associated with media production service requests received by a specific client and record information associated with those requests in a history. For example, recorded information may include a history of selected service providers, service descriptions, budgets, schedules, media formats, genres, etc. The client history may be used to further narrow search results on future media production service requests received form the client. For example, if a client has indicated that he/she had a particularly good experience with a specific service provider, the service provider may receive a higher rank or priority over other service providers in future searches performed for that client.

In an embodiment, the service provider discovery engine 440 may be configured to identify new service providers to be included in the collective database of service providers. In an embodiment, the service provider discovery engine 440 may generate or serve an advertisement for service providers. In another embodiment, the service provider discovery engine 440 may automatically crawl specified websites or media content to identify names of service providers. The identified service providers may be automatically contacted and solicited to apply to the collective. For example, the service provider discovery engine 440 may crawl credits of a video, commercial, film, or the like to identify individuals or companies associated with the production of that media. The service provider discovery engine 440 may then search for contact information for the service provider using industry databases, telephone books, the internet, or the like. If contact information is discovered, an automated solicitation may be sent to the service provider requesting that the service provider submit an application to the collective. In still another embodiment, the service provider discovery engine 440 may receive a list of potential contacts from a collective broker, or from a contact list provider. The service provider discovery engine 440 may automatically generate and send solicitation to the service providers identified on the list. Solicitations may include emails, automated telephone calls, auto-dialed personal calls, text messages, etc.

The service provider vetting engine 442 may be configured to assist the collective broker with vetting the service providers to ensure that the service providers meet quality standards, capability standards, and other managed standards. For example, the service provider vetting engine may display a summary of information received from in a service provider application submitted by a service provider to the collective broker. The service provider vetting engine 442 may automatically verify certain information received, for example verifying that contact information is valid and active. In a further embodiment, the service provider vetting engine 442 may automatically generate a vetting information request to be communicated to a reference provided by the service provider. The vetting information request may include a fillable form that is generated by the service provider vetting engine 442 and communicated, by email for example, to an individual identified as a reference for the service provider. The service provider vetting engine 442 may further summarize or display the information received from the reference for the collective broker to review. One of ordinary skill may recognize additional vetting functions that may be performed by the service provider vetting engine 442.

In an embodiment, the service provider approval manager 444 may handle approvals of service providers for inclusion in the collective database of service providers. For example, the service provider approval manager 444 may include an interface to collective broker interface device 112 for allowing the collective broker to indicate approval of the service provider. In a further embodiment the service provider approval manager 444 may update the collective database with an updated approval status. The service provider approval manager 444 may further generate an automatic notification to the service provider indicating an updated approval status, etc.

The service provider search engine 446 may use information provided by the client in the media production service request or provided by a user in a fillable search form to generate a query of the collective service provider database. The query may search the database according to one or more indexable search criteria. For example, the search may be conducted according to geographical location of the service provider, the type of service provided, an approval status of the service provider, etc. For example, in response to a request for a director to direct an animated comedic video commercial in Austin, Tex. within two weeks of the search date for a budget of $50,000, the search engine may automatically generate a query to return one or more service providers that match some or all of the following search criteria: Service provider type (director); media type (video commercial); media format (animation); genre (comedy); geographic location (Texas→Austin); Schedule (<2 Weeks); budget (<$50,000). The search may not provide any results that exactly match the search criteria. In such an embodiment, the search criteria may be prioritized or weighted, so that partial matches may be a returned. The weight or priority may be provided by the client. Alternatively, the weight or priority may be derived from the client history data generated by client history tracking engine 438.

In an embodiment, the service provider ranking engine 448 may provide an indication of a rank based on the extent to which the service provider record matches the search criteria. In a further embodiment, the service provider ranking engine 448 may generate the rank based on the one or more identified priorities or weights. The service provider ranking engine 448 may further rank the service providers base on a history of service provider reviews provided by clients of the service providers.

For example, the experience review engine 450 may automatically generate a service review and communicate the service review to a client upon completion of a project. In an embodiment, the service provider review may include a score obtained from a survey. In another embodiment, the service provider review may include comments provided by the client regarding the service provider's performance. In a further embodiment, the experience review engine 450 may obtain a review or survey from the client regarding the client's experience with the collective broker, the service provider search service, customer service, or the like. The survey results may be used to enhance future customer experiences, and may be recorded by the client history tracking engine 438.

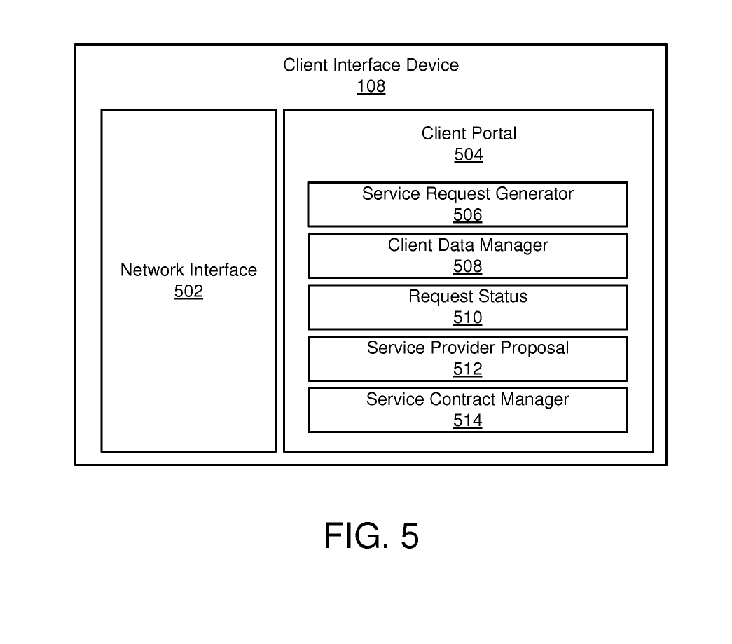

FIG. 5 is a schematic block diagram illustrating one embodiment of a client interface device 108. In an embodiment, the client interface device 108 may include a network interface 502 configured to communicate with the server 102, the service provider interface devices 110a, b, or the collective broker interface device 112 via network 106. Additionally, the client interface device may include a client portal 504. The client portal 504 may be a software application, a web application, or the like. In one embodiment, the client portal 504 may include a secure connection to the collective brokerage and search service hosted by the server 102 and/or the collective broker interface device 112.

In an embodiment, the client portal 504 may include a service request generator 506. The service request generator 506 may include, for example, a fillable form for receiving responses to required request information. Request information may include information required to perform the service provider search, including the type of requested service, schedule, budget, genre, media format, etc. The form may be displayed on a designated service request page of a web site. Alternatively, the form may be displayed in a service request panel of a portal application. Alternatively, the form may be received in an email by the client interface device 108 and may be fillable using, for example, Adobe® Acrobat®, or the like. One of ordinary skill will recognize a variety of embodiments of a service request generator 506. For example, the service request generator 506 may include a link to an email directed to a collective broker, or a telephone connection to an automated request message service, or a telephone connection to a live agent for receiving the request.

The client data manager 508 may be a panel in the client portal for entering and/or updating the client's contact information, including name, company, title, address, telephone number, email address, web address, etc. The client data manager 508 may be a section of the fillable form, or may be a separate form provided by form manager 414. The client data may be stored separately from an individual request, so that the client does not need to re-enter the client information for each and every media production service request.

The request status 510 panel may be configured to display a status of the request. In a further embodiment, the request status 510 panel may display an acknowledgement from the notification manager. Examples of status designations may include: “request incomplete;” “request received;” “searching;” “search results pending;” “search results available;” “selection complete;” “contracts pending;” “contracts available,” etc.

The service provider proposal 512 may be a panel in the client portal 504. Alternatively, the service provider proposal 512 may be communicated to the client interface device 108 via email, via a web page, or the like. In an embodiment, the service provider proposal may include a listing of one or more matches identified by the service provider search engine 446 and/or the collective broker. In one embodiment, the service provider proposal 512 may include an identification of the service provider, a ranking of the service providers according to one or more ranking criteria, a listing of pertinent information associated with the service provider and/or the request; a summary of previous history between the client and the service provider, etc.

In an embodiment, the service contract manager 514 may interface with service contract generator 436. The service contract manager 514 may facilitate review of service contracts between the client and the collective broker and/or between the client and a selected service provider. The service contract manager 514 may further facilitate electronic execution of the service contracts. The copies of service contracts may be stored in the data storage 104 and accessible by the client via the service contract manager 514. In such embodiments, the service contact manager 514 may establish a secure connection with the server 102 and/or the data storage device 104.

One of ordinary skill may recognize additional elements which may be included in the client portal 504 and/or the client interface device 108 to facilitate performance of embodiments of the methods and processes described herein.

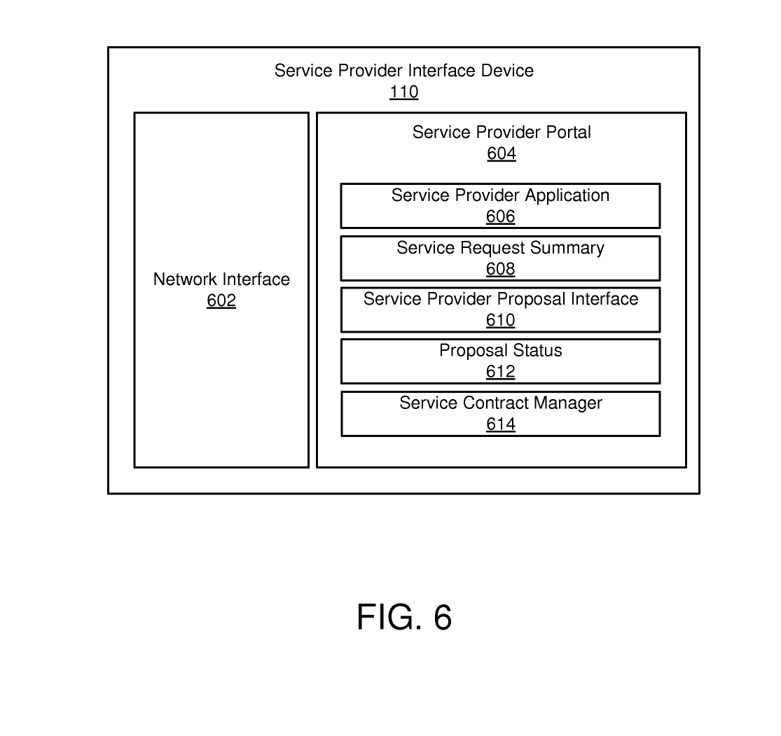

FIG. 6 is a schematic block diagram illustrating one embodiment of a service provider interface device 110. In an embodiment, the service provider interface device 110 includes a network interface 602 configured to allow the service provider interface device 110 to communicate with the server 102, the collective broker interface device 112, and/or the client interface device 108 via the network 106. In an embodiment, the service provider interface device may additionally include a service provider portal 604. The service provider portal 604 may include a service provider application 606, a service provider request summary 608, a service provider proposal interface 610, a proposal status indicator 612, and/or a service contract manager 614.

The service provider application 606 may include a fillable form presented on a designated web page, in a panel of a portal application, or the like. The service provider application 606 may prompt the service provider to fill in information used for vetting the service provider, searching for the service provider, and matching the service provider to client requests. The service provider application 606 may request contact information as well as service specific information such as the type of service provided, acceptable budget ranges, acceptable schedule ranges, special capabilities, genres, union status, etc. Additionally, if the service provider uses an agent or representative, the contact information for the agent or representative may be provided in the service provider application 606.

The service request summary 608 may be displayed in a web page or in a panel of the service provider portal 604. The service request summary 608 may present information provided by the client that describes the requested service. For example, the service request summary 608 may include a description of the job, the budget, schedule, location, forum, media type, genre, etc.

The service provider proposal interface 610 may be used by the service provider to prepare a job-specific proposal. For example, the service provider may be given one or more options for amending his service provider profile, preparing a budget/schedule quotation, indicating relevant experiences or references, or the like.

The proposal status 612 panel may indicate the status of the service provider's proposal to the client. For example, proposal status designations may include “proposal requested;” “proposal incomplete;” “proposal submitted;” “proposal under review;” “proposal denied;” “proposal accepted,” or the like.

In an embodiment, the service contract manager 614 may interface with service contract generator 436. The service contract manager 614 may facilitate review of service contracts between the service provider and the collective broker and/or between the service provider and the client. The service contract manager 614 may further facilitate electronic execution of the service contracts. The copies of service contracts may be stored in the data storage 104 and accessible by the service provider via the service contract manager 614. In such embodiments, the service contact manager 614 may establish a secure connection with the server 102 and/or the data storage device 104.

One of ordinary skill may recognize additional elements which may be included in the service provider portal 604 and/or the service provider interface device 110 to facilitate performance of embodiments of the methods and processes described herein.

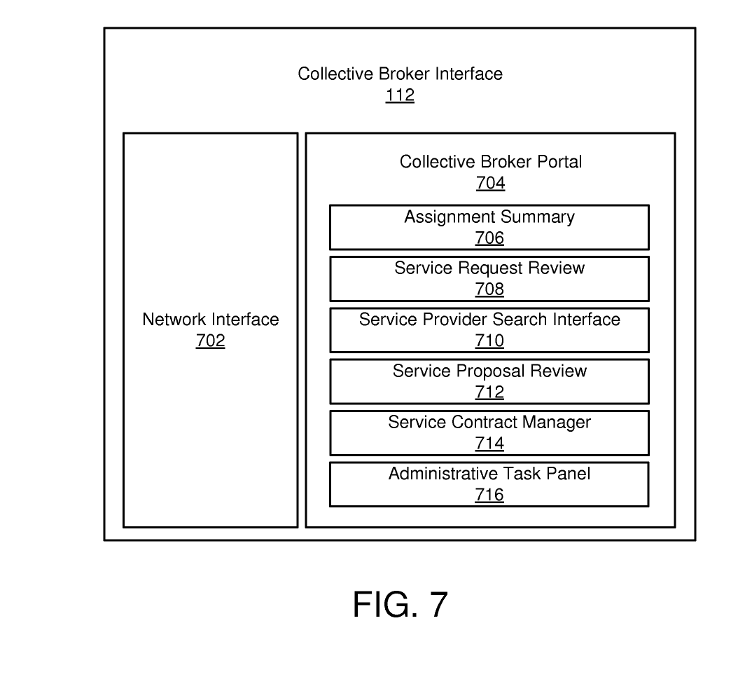

FIG. 7 is a schematic block diagram illustrating one embodiment of a collective broker interface device 112. In an embodiment, the collective broker interface device 112 may include a network interface 702 configured to communicate with the server 102, the client interface device 108, and the service provider interface device 110 via network 106. The collective broker interface 112 may additionally include a collective broker portal 704. The collective broker portal 704 may be a web-based application, a local client application, or the like. In an embodiment, the collective broker portal 704 may include an assignment summary 706 panel, a service request review 708 panel, a service provider search interface 710, a service proposal review 712, a service contract manager 714, and an administrative task panel 716.

In an embodiment, the assignment summary 706 may provide the collective broker with a summary of media production requests assigned to the specific collective broker. In another embodiment, the assignment summary 706 may include a summary of a specific or selected media production service request. The assignment summary 706 may include information that is critical to fulfillment of the request, including service description, schedule, budget, response deadlines, etc.

The service request review panel 708 provide specific information provided by the client in the media production service request. For example, the service request review panel 708 may be used to review story boards, job specifications, client history information, etc. The collective broker may reference the service request review panel 708 to generate search parameters, or narrow search results to match the service request.

The service provider search interface 710 may provide an interactive interface for allowing the collective broker to design a service provider search query. In another embodiment, the service provider search interface 710 may allow the collective broker to modify an automatically generated query. In still a further embodiment, the service provider search interface 710 may allow the collective broker to view search results. The collective broker may be able to refine search parameters in response to search results using the service provider search interface 710. In one embodiment, the service provider search interface 710 may include one or more text entry fields. The fields may be selectable, for example radio buttons, or drop-down boxes. Alternatively, the fields may include a field for entering search terms and connectors, Boolean search terms, and/or natural language search terms.

The service proposal review 712 panel may display one or more service proposals generated by the service providers via service provider interface 110. In another embodiment, the service proposal review 712 panel may display a service proposal generated by the collective broker in response to the service provider search results and/or proposals generated identified service providers. The collective broker may edit or modify the service proposal via the service proposal review 712 panel. Additionally, the collective broker 712 may approve a service proposal and send the service proposal to the client via the service proposal review 712 panel.

In an embodiment, the service contract manager 714 may interface with service contract generator 436. The service contract manager 714 may facilitate review of service contracts by the collective broker. The service contract manager 614 may further facilitate electronic execution of the service contracts by the collective broker or legal representative of the collective broker. The copies of service contracts may be stored in the data storage 104 and accessible by the collective broker via the service contract manager 714. In such embodiments, the service contact manager 714 may establish a secure connection with the server 102 and/or the data storage device 104.

In an embodiment, the administrative task panel 716 may allow the collective broker 704 to handle administrative tasks associated with the media production service request. For example, administrative tasks may include billing and collections, customer satisfaction surveys, client history tracking, collective broker notes retention, service provider vetting, etc. The administrative task panel 716 may interface with various components of the collective broker engine 306, including the billing manager 424, the notification manager 420, the client history tracking engine 438, the experience review engine 450, the service provider vetting engine 442, and the like.

One of ordinary skill may recognize additional elements which may be included in the collective broker portal 604 and/or the collective broker interface device 112 to facilitate performance of embodiments of the methods and processes described herein.

FIG. 8 is a schematic flowchart diagram illustrating one embodiment of a method 800 for intelligent media production. In an embodiment, the method 800 starts at block 802 when the server 102 receives an electronic request for a media production service from a media production client via client interface device 108. The request may be communicated over network 106. In an embodiment, the client may enter information comprising the request via client portal 504. The service provider search engine 446 may then search a pre-compiled set of service providers to identify a sub-set of service providers that are suitable for providing the media production service to the client, as shown at block 804. In an embodiment, the pre-compiled set of service providers are stored in a collective broker database stored on data storage device 104. The client interface device 108 may then electronically present the sub-set of service providers to the media production client as shown at block 806. The server 102 may then receive a selection of a service provider from the media production client 808 via the client interface device 108, as shown at block 808.

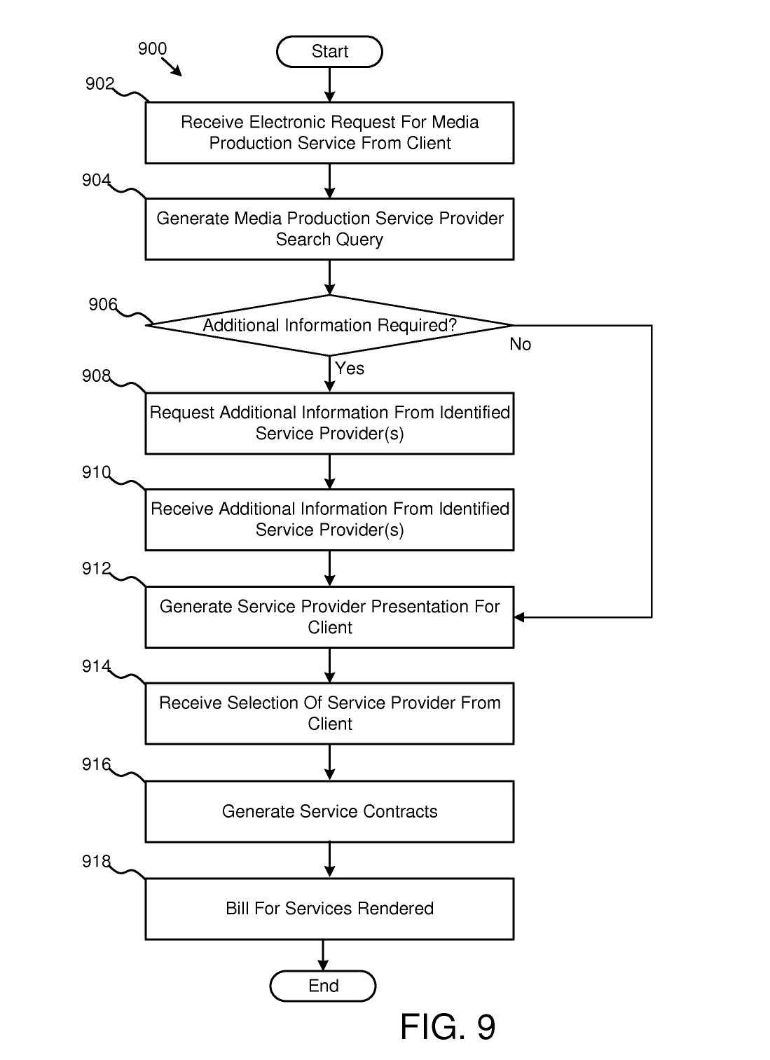

FIG. 9 is a schematic flowchart diagram illustrating another embodiment of a method 900 for intelligent media production. In an embodiment, the method 900 starts when the server 102 receives an electronic request for a media production service from a client via client interface device 108, as shown at block 902. At block 904, the service provider search engine 446 generates a media production service provider search query in response to the information received in the electronic request. Once the results are obtained, a determination is made at block 906 as to whether additional information is required from the media production service provider(s). If so, the information request manager 428 may request additional information from the identified service providers, as shown at block 908, and the additional information may be received as shown at block 910. The collective broker may then review a service proposal using service proposal review 712 panel, as shown at block 912. The client may enter a selection of a service provider via the client portal 504 as shown at block 914. The service contract generator 436 may then generate one or more service contracts as shown at block 916. The service contracts may be reviewed and/or executed using service contract managers 514, 614, 714. The billing manager 424 may then bill the client for services rendered as shown at block 918. One of ordinary skill will recognize that additional or fewer functions may be performed according to the method 900. For example, additional functions as described above with relation to FIGS. 3-7 may be included in method 900 in various embodiments.

FIG. 10 is a schematic flowchart diagram illustrating one embodiment of a method 1000 for adding a service provider to a collective database of media production service providers. In an embodiment, the method 1000 starts when the service provider discovery engine 440 discovers a new media production service provider as shown at block 1002. The collective broker engine 306 may then receive an application from the discovered media production service provider as shown at block 1004. For example, the media production service provider may enter the application using service provider application panel 606 of the service provider portal 604. The service provider vetting engine 442 may then vet the service provider as shown at block 1006. Examples of vetting are described above with reference to element 442 of FIG. 4. A determination may then be made as to whether the media production service provider is approved or not as shown at block 1008. If so, the collective broker engine 306 may add the media production service provider to the collective broker database on data storage device 104 as shown at block 1010. Either way, the notification manager 420 may notify the media production service provider of the application status as shown at block 1012.

FIG. 11 is a schematic block diagram illustrating one embodiment of a system 1100 for remote post-production editing and collaboration. In an embodiment, the system 1100 includes an application server 1102. The application server 1102 may be coupled to a network 1104. Additionally, an editor interface system 1106 and a host interface system may be coupled to the network 1104. The application server 1102, the editor interface system 1106, and the host interface system 1108 may access post-production data stored on post-production data storage device 1110 and media files stored on media storage device 1112. In one embodiment, post-production data storage 1110 and media storage 1112 may be consolidated. In other embodiments, post-production data storage 1110 and media storage 1112 may be stored on a cloud data storage system or stored in a distributed data storage configuration.

In an embodiment, the application server 1102 may host and provide access to one or more applications configured to facilitate post-production editing and collaboration. For example, the application server 1102 may host post-production editing software such as: Adobe® Premiere®, Final Cut Pro®, Avid®, Sony® Vegas®, Cinelerra®, or Lightworks®. One of ordinary skill may recognize alternative or additional post-production editing software packages that may be hosted and served by application server 1102. In further embodiments, the application server 1102 may provide access to coloration software, visual effects and animation software, music track editing software, sound effects software, image editing software, and the like. Additionally, the application server 1102 may host and provide access to one or more collaboration software packages, including a virtual whiteboard application, a video conferencing application, etc. In still a further embodiment, the application server 1112 may host software for control of a virtual presence system.

In an embodiment, the editor interface system 1106 may be configured to access the application server 1102, the post-production data storage device 1110 and the media storage device 1112 via post-production network 1104. The editor interface system 1106 may provide an interface for allowing the editor to remotely access the media files stored in media storage 1112 and edit them using post-production editing software which is streamed or centrally served from application server 1112. For example, the editor interface system 1106 may include a thin client for accessing software stored on the application server. In another embodiment, the editor interface system 1106 may provide remote desktop access to application server 1112. In still another embodiment, the application server may stream the post-production editing software to the editor interface system 1106. In another embodiment, the application server 1112 may be a cloud server system which is remotely accessible via editor interface system 1106. Editor interface system 1106 may further comprise controls for a virtual presence system. The virtual presence system may create an interactive experience at the post-production host location which facilitates collaboration between the editor and the media producers and the media production clients located at the post-production host site.

The host interface system 1108 may similarly provide access to the application server 1112 in embodiments where a second editor interface is located on-site at the post-production host location. In addition, the host interface system may include a virtual presence system configured to provide an interactive and collaborative experience for the media producer and/or the media production client located at the host site. Host interface system 1108 may additionally include viewing devices for reviewing edited media displayed by the editor from a remote location.

Media storage device 1112 may centrally store original copies of all media generated during production. For example, all raw footage captured by film crews, all music files recorded by or otherwise obtained by a music director, and final products may be stored on media storage 1110. Beneficially, such an embodiment may promote security and protection of raw media files. Additionally, the producer is then able to maintain access to the media files for product reels or for future productions.

Post-production data storage 1110 may store information generated by the editor or by editing software hosted by application server 1112. For example, media editing project files comprising edits to the raw media files may be stored on the post-production data storage device 1110. Communications, such as emails, specifications, storyboards, may additionally be stored on data storage device 1110.

Post-production network 1104 may be a specially designed network configured to minimize latency and maximize bandwidth on data connections between the editor interface system 1106 and applications server 1102, in particular. For example, application server 1112 may be coupled to a high bandwidth and low latency carrier network such as a gigabit Ethernet or fiber optic network. In an embodiment, the post-production network may include a direct connection to a carrier backbone or trunck, such as a T1 line. Quality of Service (QoS) service level agreements with data carriers may be specified to provide minimal latency and high guaranteed bandwidths. Beneficially, such a high performance post-production network 1104 may facilitate rapid interaction between media files streaming from media storage device 1112 and editing software stored on application server 1102.

One of ordinary skill will recognize that additional or fewer components may be included in the system 1100. Further, one of ordinary skill will recognize that certain components may be consolidated. For example, post-production data storage device 1110 and media storage device 1112 may be consolidated into a single data storage system, or may be integrated with application server 1112. Beneficially, the embodiments described in FIG. 11 may provide centralized storage of digital assets, such as video, audio, animation, graphics, etc. Additionally, such embodiment may enable automation of repetitive processes in the management of digital assets such as transcoding, project structure setup, project import and export, etc. Version control may also be implemented due to the centralized storage of media and editing files. Remote access to editing systems and assets may reduce equipment costs and production expenses, including travel costs for editors.

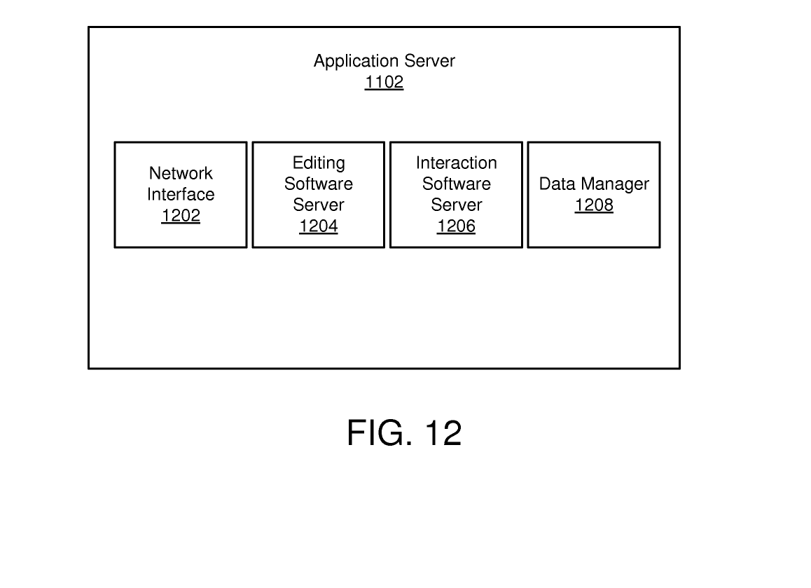

FIG. 12 is a schematic block diagram illustrating one embodiment of an application server 1102 for remote post-production editing. In an embodiment, the application server 1102 may include a network interface 1202, an editing software server 1204, an interaction software server 1206, and a data manager 1208. The network interface 1202 may be specially configured to provide high bandwidth and low latency access to application server 1102 from remote systems.

In an embodiment the editing software server 1204 may host and provide remote access to editing software. Editing software for video, audio, graphics, or the like may be hosted. In an embodiment, certain functions may be automated due to central hosting of the editing software. For example, auto transcoding and/or project file generation may be performed by editing software server 1204. In such an embodiment, a predefined editing project template may be generated and centrally stored. Thus, project setup time may be reduced, and the project setup may be consistent for all projects edited with software hosted by editing software server 1204. New media files may be automatically transcoded and placed into the editing project intelligently. Project setup and transcoding automation may be accomplished with custom automation scripts or macros configured to run on editing software server 1204. One of ordinary skill will recognize a variety of project setup, transcoding, and other tasks that may be automated by use of a centralized editing software server 1204.

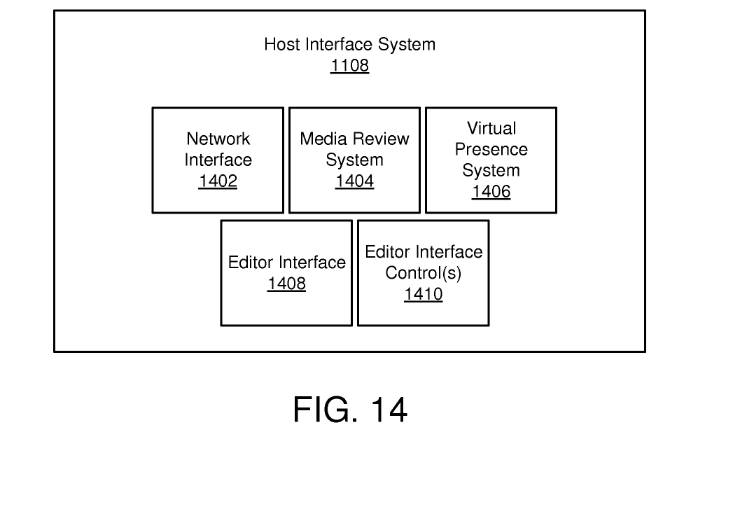

In an embodiment, the interaction software server 1206 may provide access to, and control of, a virtual presence system 1406 described below with reference to FIG. 14. In one embodiment, the interaction software server 1206 may host and provide access to virtual whiteboard software, video conferencing software, voice conferencing software, limited interactive controls of editing software, collaborative file access, and the like.

Data manager 1208 may provide an interface between software hosted on editing software server 1204 or interaction software server 1206 and files or media stored on post-production data storage 1110 and/or media storage 1112. For example, data manager 1208 may include a SAN interface configured for high data rate access to data storage devices 1110-12. In another embodiment, the data manager 1208 may include an interface to cloud storage or the like. Data manager 1208 may further handle data backup and security procedures to ensure that the data stored in post-production data storage 1110 and media storage 1112 is secure and redundantly backed up for data protection. In an embodiment, data manager 1208 may provide redundant access interfaces to prost-production data storage 1110 and media storage 1112.

One of ordinary skill will recognize additional embodiments of application server 1102 which may be used in combination with or in replacement of the embodiments described herein. Such alternative embodiments will still fall within the embodiments described herein or equivalents.

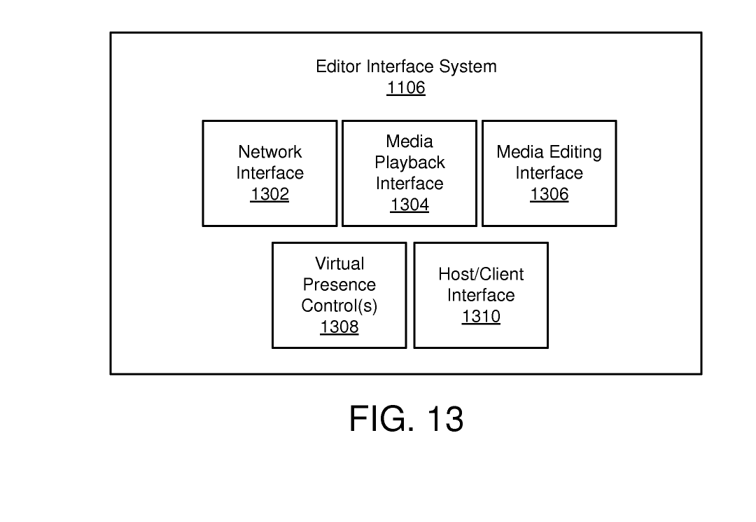

FIG. 13 illustrates one embodiment of an editor interface system 1106. The editor interface system 1106 may comprise a desktop computer, laptop computer, or the like. In an embodiment, editor interface system may be a computing device as described above with relation to FIG. 2. Editor interface system 1106 may include a network interface 1302, a media playback interface 1304, a media editing interface 1306, virtual presence controls 1308, and a host/client interface 1310.

Network interface 1302 may include a high bandwidth and low latency data connection in one embodiment. In an embodiment, the network interface 1302 may provide a virtual private network (VPN) connection to the application server 1102, post-production data storage 1110, and media storage 1112. In another embodiment, the network interface 1302 may provide a remote desktop connection to application server 1102. In still a further embodiment, network interface 1302 may provide a desktop streaming service, such as services provided by Citrix® for accessing application server 1102.

Media playback interface 1304 may obtain media form media storage 1112 and present the media to the editor. In an embodiment a buffered copy of the media file may be downloaded from media storage device 1112 and stored on local memory. Alternatively, the media file may be streamed directly from media storage device 1112. The media file may be presented to the editor via one or more interactive presentation devices, such as a video monitor or speaker system. In a specific embodiment, the media playback interface 1304 may include a true-color display device which has be specially calibrated and configured for presenting industry-recognized true color playback of media files.

Media editing interface 1306 may include a local access representation of editing software hosted by application server 1102. For example, the editor may remotely log into the application server 1102 and establish a media editing session. The editor may use local display devices and controls to interact with the editing software hosted remotely on the application server 1102. In such an embodiment, the editor may create an editing project. The editing project files may be stored on the post-production data storage device 1110. The media files may be obtained by the application server 1102 from the media storage device 1112 and played back through the application server 1102. In such an embodiment, the editor may view and edit the media files via the media editing interface by communication of editing commands to the application server via post-production network 1104.

In addition, the editor interface system 1106 may include virtual presence control(s) 1308 and a host/client interface system 1310. For example, the host/client interface system 1310 may include a video conference system, audio conference system, collaboration software interface, virtual whiteboard application, or the like. The host/client interface system 1310 allows the editor to remotely collaborate with the producer and/or the media production client for editing of the media into a final product. The host/client interface system 1310 may include a monitor and speakers. The virtual presence control(s) may include one or more controls for directing actions of a virtual presence system located at the host site. Embodiments of the virtual presence system are described below with reference to FIG. 14. The virtual presence controls 1308 may include control audio volume control or mute, microphone volume control or mute, video image control or mute, and control of an interactive virtual presence device. In an embodiment, the virtual presence control 1308 may allow the editor to present his/her image to the host location. Alternatively, the virtual presence control 1308 may allow the editor to present video playback or screen sharing with the host site.

FIG. 14 is a schematic block diagram illustrating one embodiment of a host interface system 1108 for remote post-production editing. In an embodiment, the host interface system 1108 includes a network interface 1402 for interacting with editor interface system 1106. Host interface system 1108 may additionally include a media review system 1404, a virtual presence system 1406, an editor interface 1408, and one or more editor interface controls 1410.

In an embodiment, the network interface 1402 is configured to communicate with editor interface system 1106 via the post-production network 1104. In another embodiment, the network interface 1402 is configured to communicate with the editor interface system 1106 via a separate network, because the information communicated between host interface system 1108 and editor interface system 1106 may not require as robust of network services as the information and data communicated between editor interface system 1106 and the application server 1112. Thus, a connection between a host interface system 1108 and an editor interface system 1106 may be established with a relatively lower cost network connection.

In an embodiment, media review system 1404 may include one or more video monitors and one or more speakers configured for playback of media files launched by the editor via host/client interface 1310. In one embodiment, media review system 1404 may include a true-color display device which has be specially calibrated and configured for presenting industry-recognized true color playback of media files. In a further embodiment, the true-color display device may be specifically calibrated and configured to match the color settings of the media playback interface 1304 of the editor interface system 1106.

In an embodiment the virtual presence system 1406 may enhance the interactive experience of the media production client. For example, the virtual presence system 1406 may include a robot or mannequin fitted with interactive features such as a remotely controllable rotating tablet mount for display of the editor's face and/or a remotely controllable appendage, such as an arm, hand or finger. In such an embodiment, the editor may virtually present himself as though he were actually present at the host site. The virtual presence system 1406 may additionally include high quality audio and video of the editor for enhanced interaction with the media production client.

In an embodiment, the host interface system 1108 may include an editor interface 1408 configured to display audio, video, collaborative information, and other data to the editor for the purpose of interaction and collaboration. The host interface system 1108 may additionally include one or more editor interface controls 1410 for muting or otherwise controlling the audio, video, screen share, or other interactions with the editor. Such an embodiment, may provide a degree of privacy to the media production client to discuss edits presented by the editor, etc.

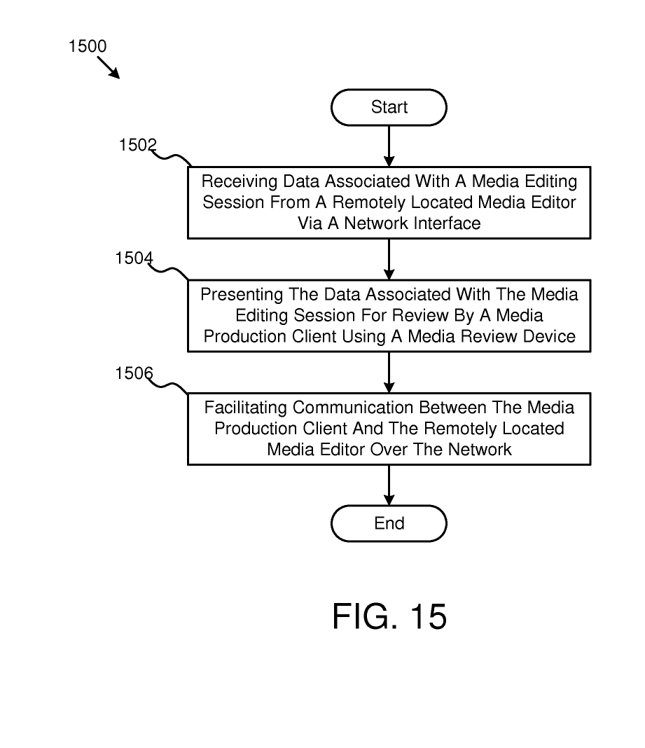

FIG. 15 is a schematic flowchart diagram illustrating one embodiment of a method 1500 for remote post-production editing. In an embodiment, the method 1500 starts when the network interface 1402 receives data associated with a media editing session from a remotely located media editor via a network interface as shown at block 1502. In an embodiment the remotely located media editor may interact with host via editor interface system 1106. At block 1504, the media review system 1404 and/or virtual presence system 1406 may present the data associated with the media editing session for review by the media production client. The editor interface 1408 and editor interface controls 1410 may facilitate communication between the media production client and the remotely located media editor over the network as shown at block 1506.

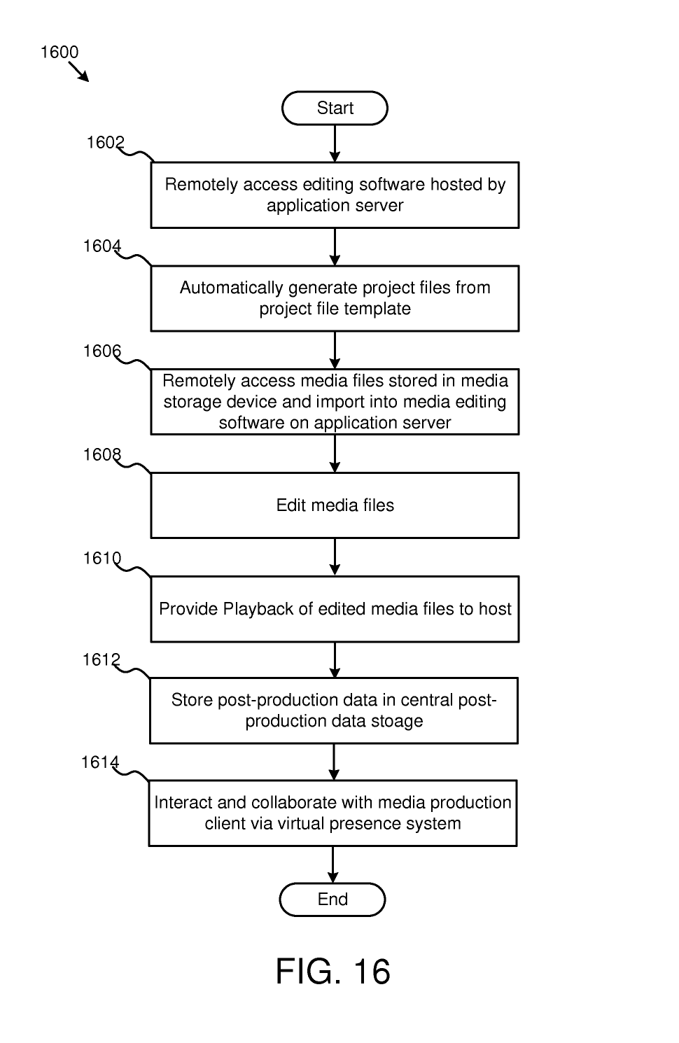

FIG. 16 is a schematic flowchart diagram illustrating another embodiment of a method 1600 for remote post-production editing. In an embodiment, the method 1600 starts at block 1602 when the media editor remotely accesses media editing software hosted by application server 1102. At block 1604, the application server 1102 may automatically generate project files from project file templates. At block 1606, the editor interface system 1106 may remotely access media files stored in the media storage device 1112 and import the media files into the media editing software on application server 1102. The media editor may then edit the media files as shown at block 1608. The media editor may then provide a playback of edited media files to host interface system 1108 as shown at block 1610. The media editor may store post-production data in a central post-production data storage device 1110 as shown at block 1612. At block 1614, the media editor may interact and collaborate with the media production client via the virtual presence system 1406 at the host interface system and/or virtual presence controls 1308.

It should be understood that the various operations described herein, particularly in connection with FIGS. 8-10 and 15-16, may be implemented by processing circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Although this disclosure makes reference to specific embodiments, certain modifications and changes can be made to those embodiments. Accordingly, the specification and figures are to be regarded in an illustrative rather than a restrictive sense, and all such modifications are intended to be included within the scope of this disclosure. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1-54. (canceled)

55. A method for hosting a media production client for a post-production editing session with a remotely located media editor, comprising:
receiving data associated with the post-production editing session from the remotely located media editor via a network interface;
presenting the data associated with the media editing session for review by the media production client using a media review device; and
facilitating communication between the media production client and the remotely located media editor over the network.

56. The method of claim 55, further comprising presenting a virtual presence of the remotely located editor in an interactive form-factor to the media production client for enhancing the client interaction experience.

57. The method of claim 56, further comprising providing a virtual presence control for facilitating the editor providing an interactive experience with the media production client.

58. The method of claim 55, further comprising storing post-production editing data in a central post-production data storage device that is remote from the editor.

59. The method of claim 55, further comprising storing the media files to be edited in a central media storage device.

60. The method of claim 55, further comprising hosting editing software used by the editor for editing the media files at a central application server.

61. The method of claim 55, further comprising providing a high performance network connection suitable for providing remote access to the application server and media files.

62. The method of claim 55, further comprising providing a host interface to facilitate the editor interacting with the host facility.

63. The method of claim 62, further comprising providing a host interface control for allowing the editor to control information presented to the host facility.

64. The method of claim 55, further comprising providing an editor interface to facilitate the host interacting with the editor.

65. The method of claim 64, further comprising providing an editor interface control for allowing the host to control information presented to the editor.

66-76. (canceled)

77. A system, comprising:
a data processing device; and
a data storage device coupled to the processing device, the data storage device comprising executable instructions configured to cause the processing device to:
receive data associated with the post-production editing session from the remotely located media editor via a network interface;
present the data associated with the media editing session for review by the media production client using a media review device; and
facilitate communication between the media production client and the remotely located media editor over the network.

78. The system of claim 77, wherein the data processor is further configured to present a virtual presence of the remotely located editor in an interactive form-factor to the media production client for enhancing the client interaction experience.

79. The system of claim 78, wherein the data processor is further configured to provide a virtual presence control for facilitating the editor providing an interactive experience with the media production client.

80. The system of claim 77, wherein the data processor is further configured to store post-production editing data in a central post-production data storage device that is remote from the editor.

81. The system of claim 77, wherein the data processor is further configured to store the media files to be edited in a central media storage device.

82. The system of claim 77, wherein the data processor is further configured to host editing software used by the editor for editing the media files at a central application server.

83. The system of claim 77, wherein the data processor is further configured to provide a high performance network connection suitable for providing remote access to the application server and media files.

84. The system of claim 77, wherein the data processor is further configured to provide a host interface to facilitate the editor interacting with the host facility.

85. The system of claim 84, wherein the data processor is further configured to provide a host interface control for allowing the editor to control information presented to the host facility.

86. The system of claim 77, wherein the data processor is further configured to provide an editor interface to facilitate the host interacting with the editor.

87. The system of claim 86, wherein the data processor is further configured to provide an editor interface control for allowing the host to control information presented to the editor.

88. A system, comprising:
a post-production network;
an application server coupled to the post-production network and configured to host and provide remote access to a post-production software application;
an editor interface system coupled to the post-production network and configured to access the post-production software application;
a data storage device configured to centrally store media files and post-production data for remote access by the editor interface system; and
a host interface system configured to provide interactive interface between a media production client hosted at a host facility and a remotely located editor via a connection between the host interface system and the editor interface system.
